(19) United States
(12) Patent Application Publication
(10) Pub. No.: US 2013/0134634 A1
(43) Pub. Date: May 30, 2013

(54) METHOD AND SYSTEM OF FEEDING CARBON NANO TUBES (CNTs) TO A FLUID FOR FORMING A COMPOSITE

(71) Applicant: Bayer Intellectual Property GmbH, Monheim (DE)

(72) Inventors: Michael Dvorak, Thun (CH); Horst Adams, Fribourg (CH)

(73) Assignee: Bayer Intellectual Property GmbH, Monheim (DE)

(21) Appl. No.: 13/720,470

(22) Filed: Dec. 19, 2012

Related U.S. Application Data
(63) Continuation of application No. 13/480,219, filed on May 24, 2012, now abandoned.
Application No. 13/480,219 is a continuation of application No. 13/264,514, now abandoned.

(30) Foreign Application Priority Data
Apr. 17, 2009 (CH) 00630/09
Feb. 2, 2010 (EP) 2010000612

(51) Int. Cl. B29B 7/24; B02C 23/18

(52) U.S. Cl. CPC B29B 7/242; B02C 23/18; B82Y 30/00
USPC 264/328.2; 164/46; 366/162.1; 241/15; 977/902

(57) ABSTRACT

Disclosed herein is a method of feeding carbon nano tubes (“CNTs”) to a fluid wherein the CNTs are provided in the form of a powder of tangled agglomerates of CNTs, the powder of tangled agglomerates is fed to a dosing chamber, a pressure pulse is applied to the dosing chamber to expel the CNTs from an outlet of the dosing chamber in such a way that the agglomerates are at least partially disintegrated by the pressure and accompanying shearing forces, and the CNTs are fed into said fluid to distribute the CNTs in the fluid and form a composite material.

### FIELD

The present invention relates to a method and a system of feeding carbon nano tubes (“CNTs”) to a fluid for forming a composite material. Preferably, the CNTs are injected into plastic material during an injection molding or extrusion process or into molten metal during a spray forming process.

### BACKGROUND ART

Carbon nano tubes (CNTs), sometimes also referred to as “carbon fibrils” or “hollow carbon fibrils”, are typically cylindrical carbon tubes having a diameter of 3 to 100 nm and a length which is a multiple of their diameter. CNTs may consist of one or more layers of carbon atoms and are characterized by cores having different morphologies.

CNTs have been known from the literature for a long time. While Iijima (S. Iijima, Nature 354, 56-58, 1991) is generally regarded as the first person to discover CNTs, in fact, fibre shaped graphite materials having several graphite layers have been known since the 1970s and 1980s. For example, in GB 14 699 30 A1 and EP 56 004 A2, Tates and Baker described for the first time the deposition of very fine fibrous carbon from a catalytic decomposition of hydrocarbons. However, in these publications the carbon filaments which are produced based on short-chained carbohydrates are not further characterized with respect to their diameter.

The most common structure of carbon nano tubes is cylindrical, wherein the CNTs may be either comprised of a single graphene layer (single-wall carbon nano tubes) or of a plurality of concentric graphene layers (multi-wall carbon nano tubes). Standard ways to produce such cylindrical CNTs are based on arch discharge, laser ablation, CVD and catalytic CVD processes. In the above mentioned article by Iijima (Nature 354, 56-58, 1991), the formation of CNTs, having two or more graphene layers in the form of concentric seamless cylinders using the arch discharge method, is described. Depending on a so-called “roll up vector,” chiral and antichiral arrangements of the carbon atoms with respect to the CNT longitudinal axis are possible.

In an article by Bacon et al., J. Appl. Phys. 34, 1960, 283-290, a different structure of CNT consisting of a single continuous rolled up graphene layer is described for the first time, which is usually referred to as the “scroll type.” A similar structure comprised of a discontinuous graphene layer is known under the name “onion type” CNT. Such structures have later also been found by Zhou et al., Science, 263, 1994, 1744-1747 and by Lavin et al., Carbon 40, 2002, 1123-1130.

As is well known, CNTs have truly remarkable characteristics with regard to electric conductivity, heat conductivity and strength. For example, CNTs have a hardness exceeding that of diamond and a tensile strength ten times higher than steel. Consequently, there has been a continuous effort to use CNTs as constituent in compound or composite materials such as ceramics, polymer materials or metals trying to transfer some of these advantageous characteristics to the compound material.

US 2007/0134496 A1 discloses a method of producing a CNT dispersed composite material, in which a mixed powder of ceramics and metal and long-chain carbon nano tubes are kneaded and dispersed by a ball mill, and the dispersed material is sintered using discharge plasma. If aluminum is used for the metal, the preferred particle size is 50 to 150 μm.

A similar method in which carbon nano materials and metal powders are mixed and kneaded in a mechanical alloying process, such as to produce a composite CNT metal powder, is described in JP 2007 154 246 A.

Another related method of obtaining a metal-CNT composite material is described in WO 2006/123 859 A1. Therein, metal powder and CNTs are mixed in a ball mill at a milling speed of 300 rpm or more. One of the main objects of this prior art is to ensure a directionality of the CNTs in order to enhance mechanical and electrical properties. According to this patent document, directionality is imparted to the nano fibrils by application of a mechanical mass flowing process to the composite material with the nano fibrils uniformly dispersed in the metal, where the mass flowing process could for example be extrusion, rolling or injection of the composite material.

WO 2008/052 642 and WO 2009/010 297 disclose a further method of producing a composite material containing CNTs and a metal. Herein, the composite material is produced by mechanical alloying using a ball mill, where the balls are accelerated to very high velocities up to 11 m/s or even 14 m/s. The resulting composite material is characterized by a layered structure of alternating metal and CNT layers, where the individual layers of the metal material may be between 20 and 200,000 nm thick and the individual layers of the CNT may be between 20 and 50,000 nm thickness. The layer structure of this prior art is shown in FIG. 11a.

As further shown in these patent documents, by introducing 6% per weight CNTs in a pure aluminum matrix, the tensile strength, hardness and module of elasticity can be significantly increased as compared to pure aluminum. However, due to the layer structure, the mechanical properties are not isotropic.

In order to provide for a homogenous and isotropic distribution of CNTs, in JP 2009 03 00 90, an alternative way of forming the CNT metal compound material is proposed. According to this document, a metallic powder having an average primary particle size of 0.1 μm to 100.0 μm is immersed in a solution containing CNTs, and the CNTs are attached to the metal particles by hydrophilization, thereby forming a mesh-shaped coating film on top of the metal powder particles. The CNT coated metallic powder can then be further processed in a sintering process. Also, a stacked metal composite may be formed by stacking the coated metal composite on a substrate surface. The resultant composite is reported to have superior mechanical strength, electric conductivity and thermal conductivity.

As is apparent from the above discussion of the prior art, the same general idea of dispersing CNTs in metal can be put to practice in numerous different ways, and the resulting composite materials may have different mechanical, electrical and thermal conductivity properties.

It is to be further understood that the above referenced prior art is still practiced on a laboratory scale only, i.e. it remains yet to be shown what type of composites can eventually be produced on a large enough scale and under economically reasonable conditions to actually find use in industry. Further, while the mechanical properties of the compound materials as such have barely been examined, it remains to be shown how the composite materials behave under further processing into an article, and in particular, to what extent the beneficial properties of the composite material as a source material can be carried over to the finished article produced therefrom and be maintained under use of the article.

EP 0 960 008 B1 describes a method for producing polyurethanes containing mechanically sensitive filler material. The system described comprises dosing means for the filler material, dosing means for polyol, a mixing screw comprising a continuous thread for mixing the filler material and polyol. It further comprises a depressurized hopper for receiving the mixture of polyol and filler material, and a screw spindle or eccentric screw pump for feeding the mixture to a mixing head for mixing the polyol including the filler material with an isocyanate component wherein the mixing head is adapted to generate a foamed part. The system is particularly suitable for using mechanically sensitive filler materials, such as expandable graphite, in polyurethane. The filler materials are not subject to any pressures higher than 20 bar, preferably not higher than 10 bar.

WO 03/029762 A1 describes a method and device for conveying dosed quantities of a fine-grained bulk material, suitable for dosing different amounts of materials to be used e.g. in a coating process or for recipes of all types, such as in chemistry, medicine and bakeries. The device of WO 03/029762 A1 uses at least two dosing chambers which can be filled and discharged alternately using pressure lines and vacuum lines connected to the dosing chambers so as to create a continuous stream of bulk material.

A method and system of spray forming articles from molten metal has been developed by Sandvik Osprey Ltd., UK, and is described in GB 1 379 261 A and GB 1 472 939 A as well as on the website of Sandvik Osprey Ltd., at www.smt.sandvik.com/osprey. Spray forming of metal articles also is known in the art as spray casting, spray deposition or in-situ compaction.

It is an object of the invention to provide a new method and system of producing a composite material comprising carbon nano tubes (CNTs) dispersed in a plastic or metal material and having superior mechanical properties such as hardness, tensile strength and Young modulus.

### SUMMARY OF THE INVENTION

The present invention provides a method and system of feeding particular carbon nano tubes (CNTs) to a fluid as well as methods and equipment for producing a semi-finished or finished article on the basis of the feeding method/system. According to the invention, the CNTs are provided in the form of a powder of tangled agglomerates of nano particles, the powder is fed to a dosing chamber, and a pressure pulse is applied to the dosing chamber to expel the CNTs from an outlet of the dosing chamber in such a way that the agglomerates are at least partially disintegrated by said pressure pulse and accompanying shearing forces. The agglomerates are fed into a fluid, such as a stream of molten or plasticized plastic or molten metal material, to distribute the CNTs in the fluid and form a composite material. The composite material is used for producing semi-finished or finished articles, e.g. by extrusion, injection moulding or spray compaction.

A further problem arising in the prior art is related to possible exposure when handling CNTs (see e.g., Baron P. A. (2003) “Evaluation of Aerosol Release During the Handling of Unrefined Single Walled Carbon Nanotube Material”, NIOSH DART-02-191 Rev. 1.1 April 2003; Maynard A. D. et al. (2004) “Exposure to Carbon Nanotube Material: Aerosol Release During the Handling of Unrefined Singlewalled Carbon Nanotube Material”, Journal of Toxicology and Environmental Health, Part A, 67:87-107; Han, J. H. et al. (2008) ‘Monitoring Multiwalled Carbon Nanotube Exposure in Carbon Nanotube Research Facility’, Inhalation Toxicology, 20:8, 741-749)).

According to a preferred embodiment, this can be minimized by providing the CNT in form of a powder of tangled CNT agglomerates, having a mean size sufficiently large to ensure easy handling because of a low potential for dustiness. Preferably at least 95% of the CNT agglomerates have a particle size larger than 100 μm. Preferably, the mean diameter of the CNT agglomerates is between 0.05 and 5.00 mm, preferably 0.10 and 2.00 mm and most preferably 0.20 and 1.00 mm.

Accordingly, the CNTs to be processed with the metal or plastic fluid can be easily handled with the potential for exposure being minimized. With the agglomerates being larger than 100 μm, they can be easily filtered by standard filters, and a low respirable dustiness in the sense of EN 15051-B is guaranteed. Further, the powder comprised of agglomerates of this large size has a pourability and flowability which allows for easy handling of the CNT source material.

While one might expect at first sight that it could be difficult to uniformly disperse the CNTs on a nano scale while providing them in the form of highly entangled agglomerates on a millimetre scale, it has been confirmed by the inventors that a homogeneous and isotopic dispersion throughout the compound is in fact possible using the method and system according to the invention. The pressure pulses applied to the dosing chamber do not only expel the powder from the outlet of the dosing chamber in well-controlled quantities, hence precisely metering the CNTs. But, the pressure pulses also have the effect that the tangled agglomerates of CNTs are broken or disintegrated and hence de-agglomerated to form isolated CNTs which can be introduced into the metal or plastic fluid without having to be handled by an operator. The tangled structure and the use of large CNT agglomerates can even help to preserve the integrity of the CNTs when it is fed from the dosing chamber using high pressure pulses. When feeding the CNTs using pressure pulses, the high acceleration forces generate high force gradients and shearing forces so that the agglomerate of tangled CNTs can be mechanically disintegrated, whereas non-agglomerated CNTs might even be damaged.

The present invention therefore takes advantage of the good processability, such as pourability and flowability as well as filterability, and the reduced health risk of CNT agglomerates, without requiring a dedicated processing step for de-agglomerating the CNTs before they are injected into the fluid to form a composite material. The agglomeration takes place “automatically” in the feeding process of the invention.

The de-agglomeration and dosing of the CNTs can be controlled by controlling at least one of an absolute pressure value, pulse frequency, pulse duration and pulse duty cycle of the pressure pulses.

The method of the present invention is particularly suitable for feeding CNTs into a fluid stream of a molten or plasticized material, such as a molten or plasticized plastic material or molten metal in an injection moulding process, extrusion process, spray compaction process or the like. In such processes, the deagglomerated CNTs are preferably injected into the fluid immediately before an output nozzle for outputting the fluid so as to optimize homogenous and isotopic dispersion of the CNTs throughout the compound. Feeding the de-agglomerated CNTs into the fluid stream immediately upstream of the output nozzle has the additional advantage that problems caused by de-agglomerated CNTs due to leakage in supply lines, such as the health risks described above, can be substantially avoided. The method of the present invention can also be used for adjusting a quantity of de-agglomerated CNTS for feeding the CNTs to a ball mill having a milling chamber and balls as milling members to effect mechanical alloying of a composite material comprising metal particles and CNTs.

The feeding method and system of the invention allow for a precise adjustment of the quantity of CNTs, in particular de-agglomerated CNTS, which are fed to the fluid for processing. In the art, there are no means for precisely metering the mass flow of a nano particle stream. This now can be realized by the present invention.

In a preferred embodiment of the invention, at least two dosing chambers are used, and pressure pulses are sequentially applied to the dosing chambers to sequentially expel the CNTs from respective outlets of the dosing chambers. Using two or more dosing chambers which are filled and discharged alternately allows to generate a substantially continuous stream of the CNTs to be fed into said fluid.

Preferably, the CNTs are fed, using pressure lines and suction or vacuum lines connected to the dosing chamber(s), so that the CNTs can be pneumatically drawn from a reservoir of CNTs into the dosing chamber(s) and can be pneumatically expelled from the dosing chamber(s).

Preferably, the average diameter of the CNT is 3 to 100 nm, more preferably 5 to 80 nm and most preferably 6 to 60 nm. In one embodiment where the diameter of the crystallites is in the order of 100 nm, the CNTs can have a diameter of about 10 nm; when the diameter of the crystallites is in the order of 200 nm, the CNTs can have a diameter of about 15 nm, for example. The CNTs are positioned inside the crystallites and/or along grain boundaries creating an intimate engagement and interlocking. This effect is referred to as “Nano-stabilization”.

Further, the length-to-diameter ratio of the CNT, also called the aspect ratio, is preferably larger than 3, more preferably larger than 10 and most preferably larger than 30. A high aspect ratio of the CNT again assists in the nano-stabilization of the metal crystallites.

In an advantageous embodiment of the present invention, at least a fraction of the CNTs have a scrolled structure comprised of one or more rolled up graphite layers, each graphite layer consisting of two or more graphene layers on top of each other. This type of nano tubes was, for the first time, described in DE 10 2007 044 031 A1. This new type of CNT structure is called a “multi-scroll” structure to distinguish it from a “single-scroll” structure comprised of a single rolled-up graphene layer. The relationship between multi-scroll and single-scroll CNTs is therefore analogous to the relationship between single-wall and multi-wall cylindrical CNTs. The multi-scroll CNTs have a spiral shaped cross section and typically comprise 2 or 3 graphite layers with 6 to 12 graphene layers each.

The multi-scroll type CNTs have found to be extraordinarily suitable for the above mentioned nano-stabilization. One of the reasons is that the multi-scroll CNTs have the tendency to not extend along a straight line but to have a curvy or kinky, multiply bent shape, which is also the reason why they tend to form large agglomerates of highly tangled CNTs. This tendency to form a curvy, bent and tangled structure facilitates the formation of a three-dimensional network interlocking with the crystallites and stabilizing them.

A further reason why the multi-scroll structure is so well suited for nano-stabilization is believed to be that the individual layers tend to fan out when the tube is bent, like the pages of an open book, thus forming a rough structure for interlocking with the crystallites which in turn is believed to be one of the mechanisms for stabilization of defects.

Further, since the individual graphene and graphite layers of the multi-scroll CNTs apparently are of continuous topology from the center of the CNTs towards the circumference without any gaps, this again allows for a better and faster intercalation of further materials in the tube structure, since more open edges are available forming an entrance for intercalates as compared to single-scroll CNTs as described in Carbon 34, 1996, 1301-03, or as compared to CNTs having an onion type structure as described in Science 263, 1994, 1744-47.

Subjecting the CNTs to high pressure during their feeding to and from the dosing chamber can have the additional effect that the de-agglomerated CNTs are functionalized, in particular roughened prior to being injected into the fluid.

When the nano particles are formed by multi-wall or multi-scroll CNTs, the roughening may be performed by causing at least the outermost layer of at least some of the CNTs to break by submitting the CNTs to high pressure, such as a pressure of 5.0 MPa or higher, preferably 7.8 MPa or higher. Due to the roughening of the nano particles, the interlocking effect with the metal crystallites and thus the nano-stabilization is further increased.

The present invention also provides a method and equipment for producing a semi-finished or finished article wherein the nano particle material is fed into a fluid as described above, wherein the fluid can be a stream of plasticized or molten plastic, a molten metal material or a fluid of metal particles, for example.

Plastic materials which are for use in the present invention preferably comprise a synthetic polymer material, such as PU (Polyurethane), PE (Polyethylene), PP (Polypropylene), PVC (Polyvinylchloride), PS (Polystyrol), PTFE (Polytetrafluoroethylene or Teflon® of E. I. Du Pont de Nemours and Company), PA (Polyamide), Polyester, PC (Polycarbonate), and PET (Polyethylenterephthalate). The plastic is processed e.g. by injection moulding or extrusion, as is well-known in the art.

If metal is used for forming the composite material, one preferred method of processing the metallic material, with the CNTs dispersed therein, is by spray forming or spray compaction, as described in GB 1 379 261 A and GB 1 472 939 A and by Osprey Metals Ltd. In this embodiment, preferably, the metal is a light metal, in particular Al, Mg, Ti or any alloy including one or more of the same, such as Al—Li alloys, Al—Ni alloys, Al—Si alloys and Al—Zn alloys. Alternatively, the metal may be Cu or a Cu alloy.

Another method of processing the metallic material, with the CNTs dispersed therein, is by mechanical alloying using a ball mill wherein the system and method of the invention are used for precisely metering the de-agglomerated CNTs into the ball mill. Preferably, the milling chamber of the ball mill is stationary and its balls are accelerated by a rotary motion of a rotating element. This design allows for easy and efficient acceleration of the balls to velocities of 8 m/s, 11 m/s or even higher, by driving the rotating element at a sufficient rotary frequency such that the tips thereof are moved at the above mentioned velocities. This is different from, for example, ordinary ball mills having a rotating drum or planetary ball mills, where the maximum speed of the balls is typically 5 m/s only. Also, the design employing a stationary milling chamber and a driven rotating element is easily scaleable, meaning that the same design can be used for ball mills of very different sizes, from laboratory type mill up to mills for high throughput mechanical alloying on an industrial scale.

For example, a batch milling process could be envisaged in which, after a predetermined amount of metal particles and CNTs have been processed by mechanical alloying, the alloy is automatically discharged and new material is supplied automatically from respective reservoirs. This requires that the CNTs are de-agglomerated and metered correctly.

As regards aluminum as a metal component, the invention allows for circumvention of many problems currently encountered with Al alloys. While high strength Al alloys are known, such as Al7xxx, incorporating Zinc, or Al8xxx, incorporating Li, according to standard EN 573-/4 based on Li. Unfortunately, coating these alloys by anodic oxidation proves to be difficult. Also, if different Al alloys are combined, due to a different electro-chemical potential of the alloys involved, corrosion may occur in the contact region. On the other hand, while Al alloys of the series 1xxx, 3xxx and 5xxx, based on solid-solution hardening can be coated by anodic oxidation, they have comparatively poor mechanical properties, low temperature stability and can only be hardened to a quite narrow degree by cold working.

In contrast to this, if a pure aluminum or an aluminum alloy forms the metal constituent of the composite material of the invention, an aluminum based composite material can be provided, which, due to the nano-stabilization effect, has a strength and hardness comparable with or even beyond the highest strength aluminum alloy available today, which also has an increased high-temperature strength due to the nano-stabilization and is open for anodic oxidation. If a high-strength aluminum alloy is used as the metal of the composite of the invention, the strength of the compound can even be further raised. Also, by adequately adjusting the percentage of CNTs in the composite, the mechanical properties can be adjusted to a desired value. Therefore, materials having the same metal component but different concentrations of CNTs and thus different mechanical properties can be manufactured, which will have the same electro-chemical potential and therefore will not be prone to corrosion when connected with each other. This is different from prior art, where different alloys need to be used when different mechanical properties are needed, and where accordingly corrosion is always an issue when different alloys are brought in contact.

It has been found that the tensile strength and the hardness can be varied approximately proportionally with the content of CNTs in the composite material. For light metals, such as aluminum, it has been found that the Vickers hardness increases nearly lineally with the CNT content. At a CNT content of about 9.0 wt %, the composite material becomes extremely hard and brittle. Accordingly, depending on the desired mechanical properties, CNT content from 0.5 to 10.0 wt % will be preferable. In particular, a CNT content in the range of 5.0 to 9.0% is extremely useful as it allows to make composite materials of extraordinary strength in combination with the aforementioned advantages of nano-stabilization, in particular high-temperature stability. In another preferred embodiment, the CNT content is between 3.0 and 6.0 wt %

The structure of the new composite material formed by the present invention has a new and surprising effect in that the micro structure of the metal crystallites is stabilized by the nano particles (CNTs). In particular, it has been observed that due to an intimate engagement or interlocking of the nano scale metal crystallites and the CNTs, dislocations in the metal can be stabilized by the CNTs. This stabilization is possible due to the extremely high surface to volume ratio of the nano scale crystallites. Also, if alloys strengthened by solid-solution hardening are used as the metal constituents, the phases of the mixed crystal or solid solution can be stabilized by the engagement or interlocking with the CNTs. Accordingly, this new effect which is observed in particular to arise for metal crystallites below 100 nm, up to below 200 nm, in combination with uniformly and preferably isotropically dispersed CNTs is called “nano-stabilization” or “nano-fixation” herein. A further aspect of the nano-stabilization is that the CNTs suppress a grain growth of the metal crystallites.

While the nano-stabilization is of course a microscopical (or rather nanoscopical) effect, it allows for production of a compound material as an intermediate product and to further manufacture a finished product therefrom having unprecedented macroscopic mechanical properties, in particular with regard to the high-temperature stability. For example, it has been observed that due to the nano-stabilization of the nano crystallites by CNT, a dislocation density and an increased hardness associated therewith can be conserved at temperatures close to the melting point of some of the phases of a metal. This means that the compound material is applicable to hot working or extrusion methods at temperatures up to the melting point of some of the phases of the metal while preserving the mechanical strength and hardness of the compound. For example, if the metal is aluminum or an aluminum alloy, the person skilled in the art will appreciate that hot working would be an untypical way of processing it, since this would usually severely compromise the mechanical properties of the aluminum. However, due to the nano-stabilization described above, an increased Young modulus and hardness will be preserved even under hot working. By the same token, final products formed from the nano-stabilized compound as a source material can be used for high-temperature applications, such as engines or turbines, where light metals typically fail due to lack of high-temperature stability.

In some embodiments of the invention, the nano particles are not only partly separated from each other by the CNTs, but some CNTs are also contained or embedded in crystallites. One can think of this as a CNT sticking out like a “hair” from a crystallite. These embedded CNTs are believed to play an important role in preventing grain growth and internal relaxation, i.e. preventing a decrease of the dislocation density when energy is supplied in form of pressure and/or heat upon processing the compound material.

Regarding the production and structure of CNTs and CNT agglomerate as well as the structure of composite materials in which CNTs are embedded in metal crystallites, explicit reference is made to the priority application PCT/EP2009/006737, the content of which is incorporated herein by reference.

### BRIEF DESCRIPTION OF THE DRAWINGS

FIG. 1 shows a schematic diagram of a setup for feeding CNTs into a fluid stream in an extruder according to an embodiment of the invention; and

FIG. 2 shows a schematic diagram of a spray forming apparatus which can be used in one embodiment of the present invention.

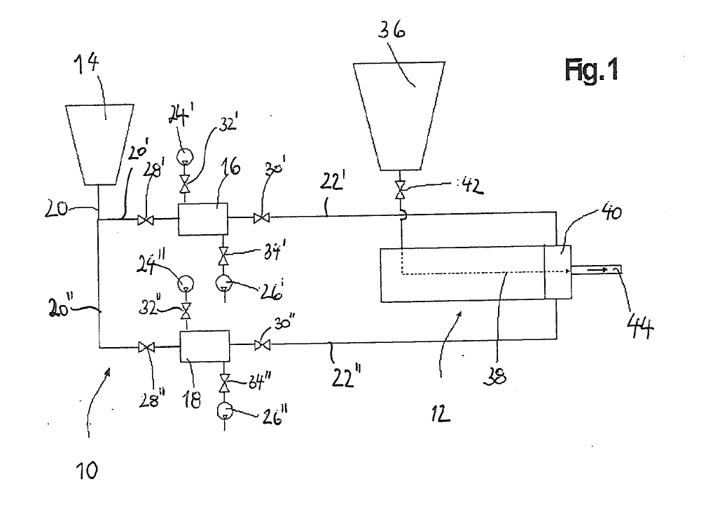

FIG. 1 schematically shows equipment for manufacturing an extruded plastic article, as one example of implementing the invention. The equipment, in general, comprises a feeding system 10 for nano articles and an extruder 12 for forming an article from a composite material, comprising a plastic, such as polyurethane or polyethylene, with CNTs dispersed therein.

The feeding system 10 of the embodiment of FIG. 1 comprises a reservoir 14 for receiving a powder of tangled agglomerates of carbon nano tubes (CNTs) and two dosing chambers 16, 18, the inputs of which are connected to the reservoir 14 via supply lines 20, 20′, 20″. The outputs of the dosing chambers 16, 18 are connected to the extruder 12 via feed lines 22, 22′, 22″.

The feeding system 10 further comprises pressure pumps 24′, 24″, or respective pressure lines and vacuum pumps 26′, 26″ or respective vacuum suction lines connected to the dosing chambers 16, 18. Valves 28′, 28″; 30′, 30″; 32′, 32″; and 34′,'34″ are provided between the dosing chambers 16, 18 and the respective supply lines 20′, 20″, feed lines 22′, 22″, pressure pumps 24′, 24″ and vacuum pumps 26′, 26″, as shown in FIG. 1.

The extruder 12 is connected to a reservoir 36 for a plastic granulate material, such as PU or PE granulate, via a supply line 38 for feeding the plastic granulate material to an extruder head 40. A valve 42 controls the flow of granulate into the extruder 12. The extruder head 40 comprises an extruder nozzle (not shown) through which extruded composite material 44 is output. The extruder 12 also comprises an extruder spindle (not shown) and other components, as well known in the art. The operation of the system shown in FIG. 1 is as follows.

The CNT agglomerates are supplied alternatingly to the two dosing chambers 16, 18 from the reservoir 14 by closing the valves 30′, 30″; 32′, 32″ and opening the valves 28′, 28″, 34′, 34″ so that the vacuum pump 26 draws CNT agglomerates from the reservoir 14 into the dosing chamber 16 or 18. The CNT agglomerates are de-agglomerated and expelled from the dosing chambers 16 and 18 by closing the valves 28′, 28″; 34′, 34″ and opening the valves 30′, 30″; 32′, 32″ so that a pressure pulse generated by the pressure pumps 24 can be applied to the dosing chambers 16 or 18. The valves, vacuum pumps and pressure pumps are controlled in such a way that while one of the dosing chambers, 16 or 18, is supplied with CNT agglomerates, in the other dosing chamber, 18 or 16, CNTs are de-agglomerated and discharged so as to generate a substantially continuous stream through the combined feed lines 22′, 22″. Feeding of the CNTs to the extruder 12 can be controlled in such a way that the cycle of supplying CNT agglomerates to the dosing chambers 16, 18 and discharging de-agglomerated CNTs from the dosing chambers 16, 18 comprises an intermediate step of purging the dosing chambers 16, 18 wherein valves 28′, 28″; 30′, 30″ are closed and valves 32′, 32″; 34′, 34″ are opened for said step of purging the dosing chambers.

In other embodiments of the invention, more than two dosing chambers 16, 18 can be provided in parallel and additional dosing chambers can be provided in series.

The absolute pressure, pulse frequency, pulse duration, and pulse duty cycle generated by the pressure pumps 24′, 24″ and the vacuum pumps 26′, 26″ can be controlled so as to adjust the amount of CNTs to be fed and to control the process of de-agglomeration of the CNTs when drawing the CNTs into the dosing chambers 16, 18 and expelling the CNTs from the dosing chambers 16, 18.

A feeding system of this type is described in detail in WO 03/029762 A1 which is incorporated herein by reference. Therefore, the system need not be described in further detail in this application.

Due to the high pneumatic acceleration forces which are applied to the tangled CNT agglomerates within the dosing chambers 16, 18, when a pressure pulse is generated by pressure pumps 24′, 24″ but also when the agglomerates are drawn into the dosing chambers 16, 18 using the vacuum pumps 26′, 26″, very high force gradients and associated shearing forces are applied to the CNT agglomerates so that the CNT agglomerates are mechanically disintegrated and are recovered as CNT in the form of tubes or fibres. These CNTs are fed into the extruder head 20 via feed lines 22′, 22″ where they are dispersed into the plasticized or molten plastic immediately upstream of the extruder nozzle. In the extruder 12, the plastic provided as a granulate or the like from reservoir 36 is processed in a way well-known in the art, plasticized or molten and extruded, wherein the amount of plastic granulate supplied can be controlled by valve 42. In the context of this application, the liquid or plasticized plastic material is considered as a fluid into which the CNTs are injected. For processing plastic materials, instead of using an extruder, the invention could also be applied to an injection moulding process, blow of moulding process, pouring process, foaming process or rather a method of plastic process known in the art or to be developed. As described above, the de-agglomerated CNTs preferably are injected into the molten or plastified plastic material immediately upstream of an output nozzle where the plastic material is still in a molten or plastified state.

Surprisingly, the inventors have found that with the method and system described herein, it is possible to achieve a homogeneous and isotropic distribution of CNTs in the plastic material which eventually is output as composite material 44.

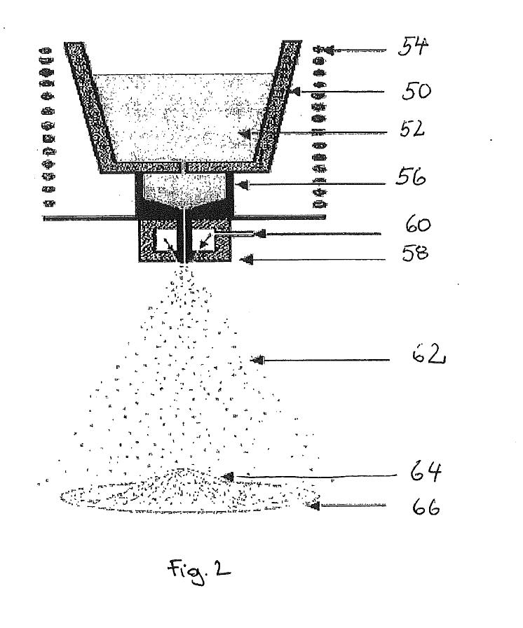

In an alternative embodiment of the invention, CNTs are injected into a molten metal or, more generally, a metal fluid which is processed to produce a finished or a semi-finished article. In the preferred embodiment, the CNTs are introduced into molten metal in spray compaction equipment, as schematically shown in FIG. 2.

The spray compaction equipment comprises a crucible 50 for holding a supply of a molten metal alloy 52, surrounded by heating means 54 for heating the metal to a liquid state. From the crucible 50 the molten metal is supplied to a flow tube 56 and further to an atomizing nozzle 58, by gravity or other means, known in the art. The atomizing nozzle 56 comprises an atomizing gas inlet 60 in order to generate atomized metal droplets 62 which form a deposit 64 on a substrate 66. This equipment is well-established in the art for manufacturing semi-finished articles which can be shaped, e.g. by pressure-moulding, to their final form.

According to the present invention, nano carbon tubes are introduced at the flow tube 56 using the feeding system of the present invention, an embodiment of which has been described with reference to FIG. 1. The de-agglomerated CNTs are introduced immediately upstream of the atomizing nozzle 58 so as to homogeneously and isotopically distribute the CNTs in the molten metal and hence in the deposit 64.

It is a remarkable advantage of the composite material of the present invention that the beneficial mechanical properties of the composite material can be maintained in the finished or semi-finished article.

Although a preferred exemplary embodiment is shown and described in detail in the drawings and the preceding specification, this should be viewed as purely exemplary and not as limiting the invention. It is noted in this regard that only the preferred exemplary embodiment is shown and specified, and all variations and modifications should be protected that presently or in the future lie within the scope of protection of the claims.

### REFERENCE NUMBERS

10 feeding system

12 extruder

14 reservoir

16 dosing chamber

18 dosing chamber

20, 20′, 20″ supply lines

22′, 22″ feed lines

24′, 24″ pressure pumps

26′, 26″ vacuum pumps

28′, 28″ valves

30′, 30″ valves

32′, 32″ valves

34′, 34″ valves

36 reservoir

38 supply line

40 extruder head

42 valve

44 extruded composite material

50 crucible

52 molten metal alloy

54 heating means

56 flow tube

58 atomizing nozzle

60 gas inlet

62 atomized droplets

64 deposit

66 substrate

1-14. (canceled)

15. A method of feeding carbon nano tubes to a fluid for forming a composite material comprising:
providing carbon nano tubes in the form of a powder of tangled agglomerates of carbon nano tubes;
feeding the powder of tangled agglomerates to a dosing chamber;
applying a pressure pulse to the dosing chamber to expel the carbon nano tubes from an outlet of the dosing chamber in such a way that the agglomerates are at least partially disintegrated by pressure and shearing forces, and
feeding the carbon nano tubes into the fluid for distribution of the carbon nano tubes in the fluid and formation of a composite material.

16. The method of claim 15, further comprising feeding the powder of tangled agglomerates to at least two dosing chambers and sequentially applying pressure pulses to the dosing chambers to sequentially expel the carbon nano tubes from respective outlets of the dosing chambers to generate a substantially continuous stream of the carbon nano tubes to be fed into the fluid.

17. The method of claim 15, wherein the powder of tangled agglomerates is pneumatically drawn from a reservoir of carbon nano tubes to the dosing chamber.

18. The method of claim 15, wherein the pressure pulse applied to the dosing chamber is controlled in terms of at least one of an absolute pressure value, a pulse frequency, a pulse duration, and a pulse duty cycle so as to control disintegration of the agglomerates and feeding of the carbon nano tubes into the fluid.

19. The method of claim 15, wherein the carbon nano tubes are fed into the fluid immediately upstream of an output nozzle for outputting the fluid.

20. The method of claim 15, wherein the pressure pulse applied to the dosing chamber is controlled to adjust a quantity of carbon nano tubes fed into the fluid.

21. The method of claim 15, wherein the tangled agglomerates are tangled carbon nano tubes agglomerates having a mean diameter between 0.05 and 5.00 mm.

22. The method of claim 15, wherein the tangled agglomerates are tangled carbon nano tubes agglomerates having a mean diameter between 0.10 and 2.00 mm.

23. The method of claim 15, wherein the tangled agglomerates are tangled carbon nano tubes agglomerates having a mean diameter between 0.20 and 1.00 mm.

24. The method of claim 15, wherein the carbon nano tubes comprise nano tubes having an average diameter of 3 to 100 nm.

25. The method of claim 15, wherein the carbon nano tubes comprise nano tubes having an average diameter of 5 to 80 nm.

26. The method of claim 15, wherein the carbon nano tubes comprise nano tubes having an average diameter of 6 to 60 nm.

27. The method of claim 15, wherein the length to diameter ratio of the carbon nano tubes is larger than 3.

28. The method of claim 15, wherein the length to diameter ratio of the carbon nano tubes is larger than 10.

29. The method of claim 15, wherein the length to diameter ratio of the carbon nano tubes is larger than 30.

30. The method of claim 15, wherein at least a fraction of the carbon nano tubes have a scrolled structure comprised of one or more rolled up graphite layers, wherein each graphite layer consists of two or more graphene layers on top of each other.

31. The method of claim 15, wherein the carbon nano tubes are fed into the fluid at a percentage by weight relative to the total composite material in the range of 0.5 to 10.0%.

32. The method of claim 15, wherein the carbon nano tubes are fed into the fluid at a percentage by weight relative to the total composite material in the range of 3.0 to 9.0%.

33. The method of claim 15, wherein the carbon nano tubes are fed into the fluid at a percentage by weight relative to the total composite material in the range of 5.0 to 9.0%.

34. A method of producing a semi-finished or finished article, comprising the steps of:
feeding carbon nano tubes to a fluid according to claim 15, wherein the fluid is plasticized or molten plastic, and
forming the article by extruding or injection moulding the composite material.

35. A method of producing a semi-manufactured or finished article, comprising the steps of:
feeding carbon nano tubes to a fluid according to claim 15, wherein the fluid is molten metal, and
forming the article by spray compaction of the composite material.

36. A method of producing a composite material including metal particles and carbon nano tubes, comprising the steps of:
feeding carbon nano tubes to a fluid according to claim 15, wherein the fluid comprises the metal particles, and
milling of the composite material, using a ball mill having a milling chamber and balls as milling members, to effect mechanical alloying of the composite material.
